(19) United States
(12) Patent Application Publication
(10) Pub. No.: US 2019/0176716 A1
(43) Pub. Date: Jun. 13, 2019

(54) APPARATUS, A VEHICLE AND A METHOD

(71) Applicant: Jaguar Land Rover Limited, Coventry (GB)

(72) Inventors: Matthew ATKINSON, Coventry (GB); Paul KELLITT, Coventry (GB); Jessica BUNYAN, Coventry (GB)

(21) Appl. No.: 16/212,962

(22) Filed: Dec. 7, 2018

(30) Foreign Application Priority Data
Dec. 7, 2017 (GB) 1720394.4

(51) Int. Cl. B60R 11/00; B60R 7/08; B60R 7/02

(52) U.S. Cl. CPC B60R 11/00; B60R 7/08; B60R 2011/0036; B60R 2011/0071; B60R 7/02

(57) ABSTRACT

An apparatus for retaining an item carried by a vehicle, a vehicle and a method. The apparatus comprises a rail and a strap anchored relative to the rail at a first anchor point. The apparatus also includes at least one component defining a passageway through which the strap extends, the at least one component being mounted to slide along the rail, towards and away from the first anchor point, to enable different items of various dimensions to be retained between the strap and the rail.

### CROSS-REFERENCE TO RELATED APPLICATION

This application claims priority under 35 U.S.C. § 119 to Great Britain Application No. 1720394.4, filed Dec. 7, 2017, the content of which is incorporated herein by reference in its entirety.

### TECHNICAL FIELD

The present disclosure relates to an apparatus, a vehicle and a method. In particular, but not exclusively it relates to an apparatus for retaining an item carried by a vehicle, a vehicle comprising such an apparatus and a method of manufacturing such an apparatus.

Aspects of the invention relate to an apparatus, a vehicle and a method.

### BACKGROUND

Retention straps may be provided within a loadspace of a vehicle to retain items and prevent their movement within the loadspace during transport. A problem exists with conventional straps which may not provide sufficient support for retaining some items, due to the varying sizes of items to be retained. For example, straps that are anchored at positions allowing them to retain bags may not be suitable for retaining bottles or a laptop.

It is an aim of the present invention to address disadvantages of the prior art.

### SUMMARY OF THE INVENTION

Aspects and embodiments of the invention provide an apparatus, a vehicle and a method as claimed in the appended claims.

According to an aspect of the invention there is provided an apparatus for retaining an item carried by a vehicle, the apparatus comprising: a rail; a strap anchored relative to the rail at a first anchor point; and at least one component defining a passageway through which the strap extends, the at least one component being mounted to slide along the rail, towards and away from the first anchor point, to enable different items of various dimensions to be retained between the strap and the rail.

This provides the advantage that items of various sizes may be retained by the strap to prevent their movement within a loadspace of a vehicle during movement of the vehicle.

Optionally, the at least one component comprises: a body portion and flanges extending from opposing sides of the body portion. Additionally, the at least one component may, for example, include a spring part that extends from one of the flanges. Optionally, the spring part may be configured to engage a groove of the rail. For example, the spring part may be configured to engage the groove to provide friction between the component and the rail. The friction may substantially inhibit movement of the component along the rail. The spring part may, for example, include a flexible projection that extends away from the body portion. The component may, for example, be slidable along the rail by compressing the spring part, whilst applying a force directed along the rail. The at least one component may comprise a plurality of spring parts. Each spring part may extend from a corner of the component. Each spring part may include a flexible projection.

In some embodiments the first anchor point is a fixed anchor point.

In some embodiments the strap is attached to the rail at at least two anchor points and the at least one component is mounted to slide along the rail between the two anchor points.

In some embodiments the strap is fixed to the first anchor point at, or adjacent to, one end of the rail and fixed to a second anchor point at, or adjacent to, an opposite end of the rail. This provides the advantage that the component may be slid to positions to enable items to be retained along the whole length of the rail.

In some embodiments the strap comprises elastic fibres to enable the strap to stretch. This provides the advantage that the strap may be positioned around an item to hold the item in place by stretching the strap over the item. For example, the strap may be stretched by pulling a section of the strap between a pair of components that each define a passageway through which the strap extends. In a stretched state, the strap may bear against at least one of the components and force at least one of the components against the rail. The force may generate friction that substantially inhibits movement of at least one of the components along the rail.

In an embodiment, the strap may be configured to bear against at least one of the components and to raise a first end of said component relative to an opposing second end of said component. The component may be disposed at an end of a stretched section of the strap. The component may, for example, be moveable along the rail by depressing the raised first end of the component and sliding the component along the rail.

For example, the strap may bear against at least one of the components, raising a first end of said component relative to an opposing second end of said component, when an item is retained between the strap and the rail. The component may be moveable along the rail by depressing the raised first end of the component.

In some embodiments the at least one component defines a passageway through which the strap is free to slide.

In some embodiments the at least one component defines a passageway between the at least one component and the rail; and the strap extends through the passageway.

In some embodiments the at least one component divides the strap into a plurality of portions, each said portion being useable to retain an item.

In some embodiments the apparatus comprises a plurality of the components. This provides the advantage that many items of various sizes may be simultaneously retained by the apparatus.

In some embodiments the rail is positioned on a panel configured to be mounted within a loadspace of a vehicle to define a loadspace.

In some embodiments the rail comprises features to enable attachment of the rail to a surface of a vehicle.

In some embodiments the apparatus comprises a panel; and the rail forms an integral part of the panel. This provides the advantage that the rail may be provided without any additional material cost or installation cost, due to it being formed at the time of forming the panel.

In some embodiments the strap is attached to the rail at at least the first anchor point.

According to another aspect of the invention there is provided a vehicle comprising the apparatus of any one of the previous claims.

In some embodiments the rail is provided on an interior surface of the vehicle. This provides the advantage that the apparatus may be used to retain items in position within the vehicle.

In some embodiments the interior surface is provided in a loadspace. This provides the advantage that the apparatus may be used to retain items in position within the loadspace.

In some embodiments the interior surface is on a panel configured to partition the loadspace.

According to a further aspect of the invention there is provided a method of manufacturing apparatus for retaining an item carried by a vehicle, the method comprising: extending a strap along a rail; anchoring the strap relative to the rail at a first anchor point; and mounting at least one component on the rail to enable the at least one component to slide along the rail, the at least one component defining a passageway through which the strap extends.

In some embodiments the first anchor point is a fixed anchor point.

In some embodiments the passageway is defined between the at least one component and the rail by said mounting the at least one component on the rail.

In some embodiments said mounting the at least one component on the rail comprises sliding the at least one component onto the rail with the strap positioned between the at least one component and the rail.

In some embodiments the rail is formed by an extrusion process or a casting process.

In some embodiments the rail is formed as an integral part of a panel by an extrusion process or a casting process. This provides the advantage that the rail may be provided without any additional material cost or installation cost, due to it being formed at the time of forming the panel.

In some embodiments the method comprises attaching the strap to the rail at at least the first anchor point.

According to yet another aspect of the invention there is provided an apparatus for retaining an item carried by a vehicle, the apparatus comprising: a rail; a strap attached to the rail at a first anchor point; and at least one component defining a passageway through which the strap extends, the at least one component being mounted to be movable between various positions along the rail, towards and away from the first anchor point, to enable different items of various dimensions to be retained between the strap and the rail.

The apparatus may be for use within a vehicle, such as a road vehicle.

According to another aspect of the invention there is provided an apparatus for retaining an item carried by a vehicle, the apparatus comprising: a rail; a strap anchored relative to the rail at a first anchor point; and at least one component defining a passageway, between the at least one component and the rail, through which the strap extends, the at least one component being mounted to slide along the rail, towards and away from the first anchor point, to enable different items of various dimensions to be retained between the strap and the rail.

According to yet another aspect of the invention there is provided a method of manufacturing apparatus for retaining an item carried by a vehicle, the method comprising: extending a strap along a rail; anchoring the strap relative to the rail at a first anchor point; and mounting at least one component on the rail to enable the at least one component to slide along the rail, the at least one component defining a passageway, between the at least one component and the rail, through which the strap extends.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a rear perspective view of a vehicle comprising an apparatus embodying the present invention;

FIG. 2 shows another rear perspective view of the vehicle;

FIG. 3 shows a front view of apparatus embodying the present invention;

FIG. 4 shows a cross-sectional side view of the apparatus of FIG. 3;

FIG. 5 shows a perspective view of the apparatus of FIG. 3;

FIG. 6 shows an end view of the rail of the apparatus of FIGS. 3 to 5;

FIG. 7 shows a front view of one of the slidable components;

FIG. 8a shows a side view of the slidable component of FIG. 7;

FIG. 8b shows a perspective view of another example of one of the slidable components;

FIG. 9 shows the apparatus of FIGS. 3 to 5 being used to retain three bottles;

FIG. 10 shows the apparatus of FIGS. 3 to 5 being used to retain an item of luggage;

FIG. 11 shows a cross-sectional side view of an alternative apparatus embodying the present invention;

FIG. 12 shows a cross-sectional side view of another alternative apparatus embodying the present invention;

FIG. 13 shows a cross-sectional side view of yet another alternative apparatus embodying the present invention;

FIG. 14 shows a perspective view of a further alternative apparatus embodying the present invention;

FIG. 15 shows a perspective view a panel that forms a part of the apparatus of FIG. 14;

FIG. 16 shows a cross-sectional view of the apparatus of FIG. 14; and

FIG. 17 shows a flowchart illustrating a method of manufacturing apparatus for retaining an item carried by a vehicle.

### DETAILED DESCRIPTION

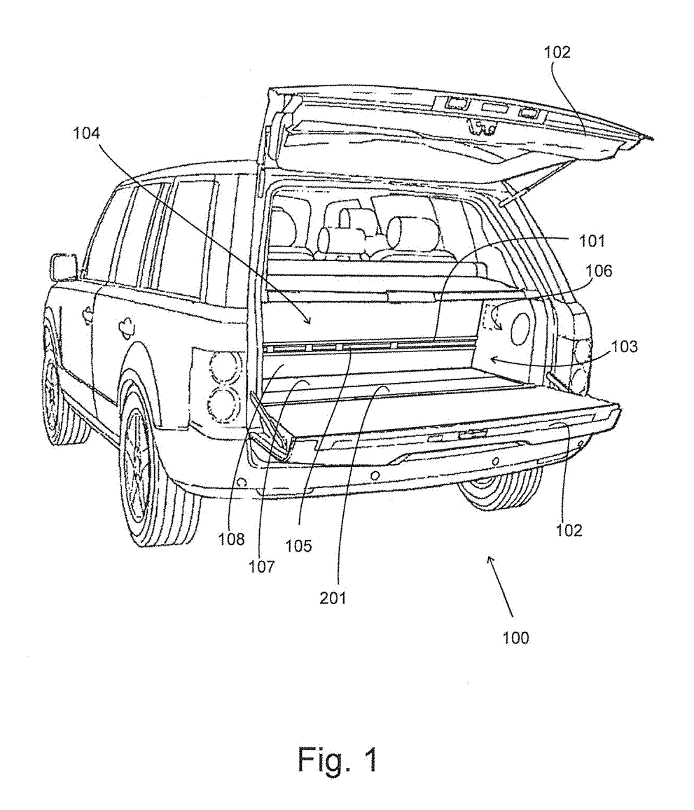

A rear perspective view of a vehicle 100 comprising an apparatus 101 embodying the present invention is shown in FIG. 1. In the present embodiment, the vehicle 100 is a car with a split tailgate 102 providing access to a loadspace 103 of the vehicle 100. However, it should be understood that in other embodiments the apparatus 101 may be fitted within the loadspace 103 of other types of vehicle. For example, the apparatus 101 may be located within the boot of another type of car such as a saloon car (or sedan).

The apparatus 101 of FIG. 1 is attached to the rear surface 104 of a panel 108 forming the backrest of the rear seats of the vehicle 100. The apparatus 101 comprises a strap 105 which may be looped around items to be transported within the loadspace 103 to prevent the items from falling over and/or sliding or rolling around the floor 107 of the loadspace 103.

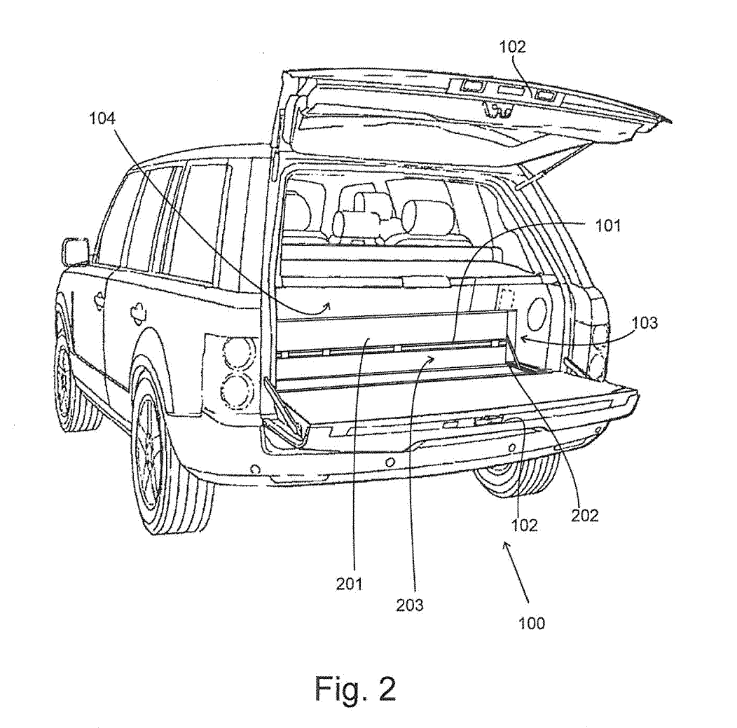

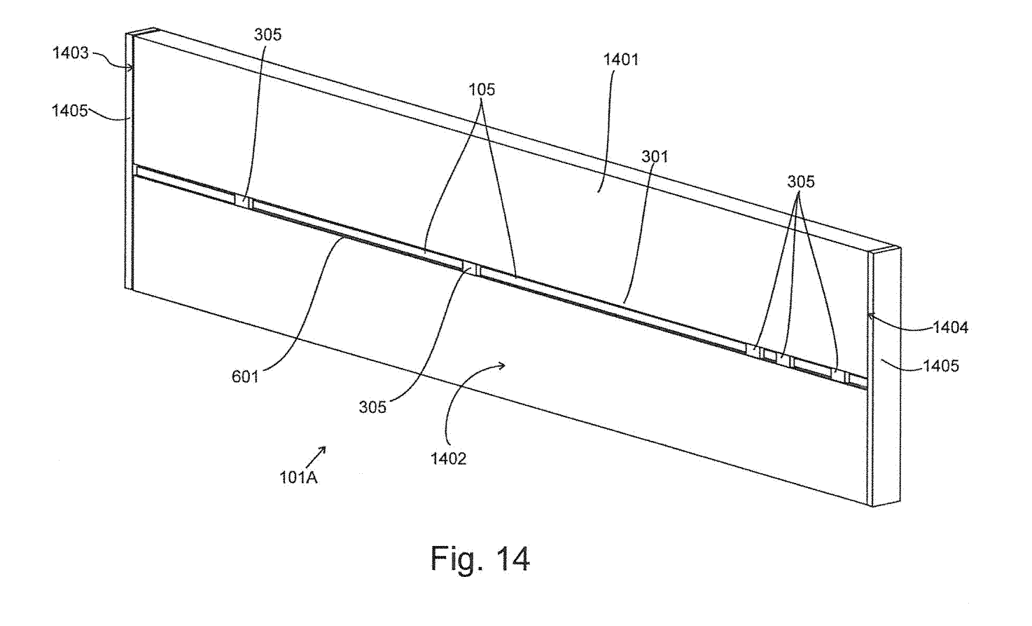

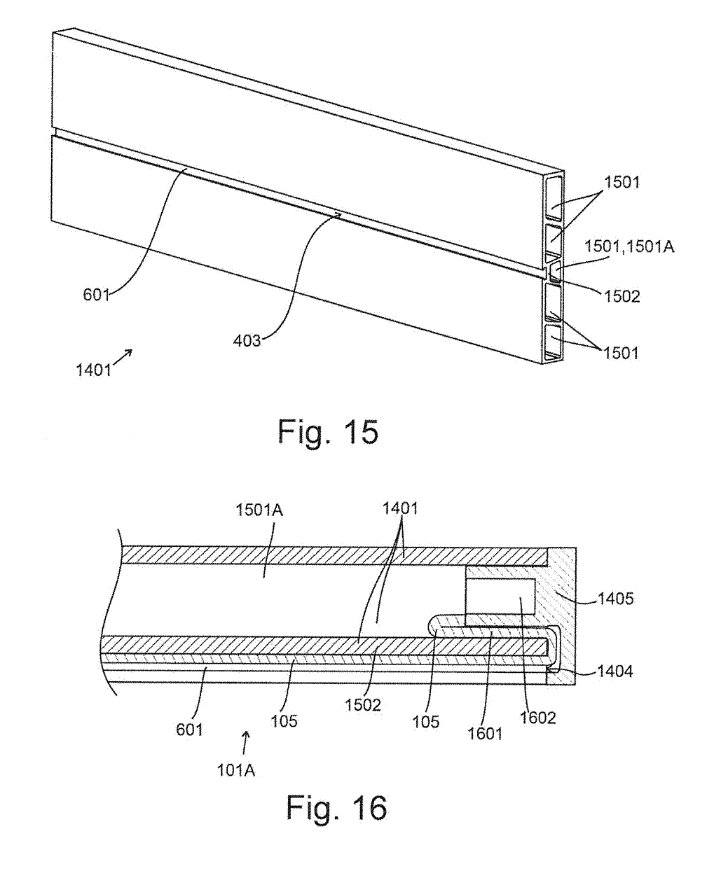

Although the apparatus 101 is positioned on the rear surface 104 of the rear seats in FIG. 1, it will be appreciated that in other embodiments apparatuses 101 in accordance with the invention may be positioned on other surfaces within the loadspace 103. For example, such an apparatus 101 may be located along the side walls 106 of the loadspace 103 or on the floor 107 of the loadspace 103. Alternatively, as shown in the rear view of the vehicle 100 in FIG. 2, the apparatus 101 may be located on a panel 201 arranged to partition the loadspace 103 into two parts. The panel 201 is arranged transversely across the loadspace 103 part way between the rear surface 104 of the rear seats and the tailgate 102. In the embodiment of FIG. 2, the apparatus 101 is mounted on a surface 203 of the panel 201, but in other embodiments the apparatus 101 may be formed as an integral part of the panel, as described with reference to FIGS. 14 and 15. In the embodiment of FIG. 2, the panel 201 is mounted on hinges 202 so that it may be moved from the deployed position, shown in FIG. 2, to a stowed position in which it resides in a substantially horizontal orientation to form a part of the floor 107 of the loadspace 103, as shown in FIG. 1.

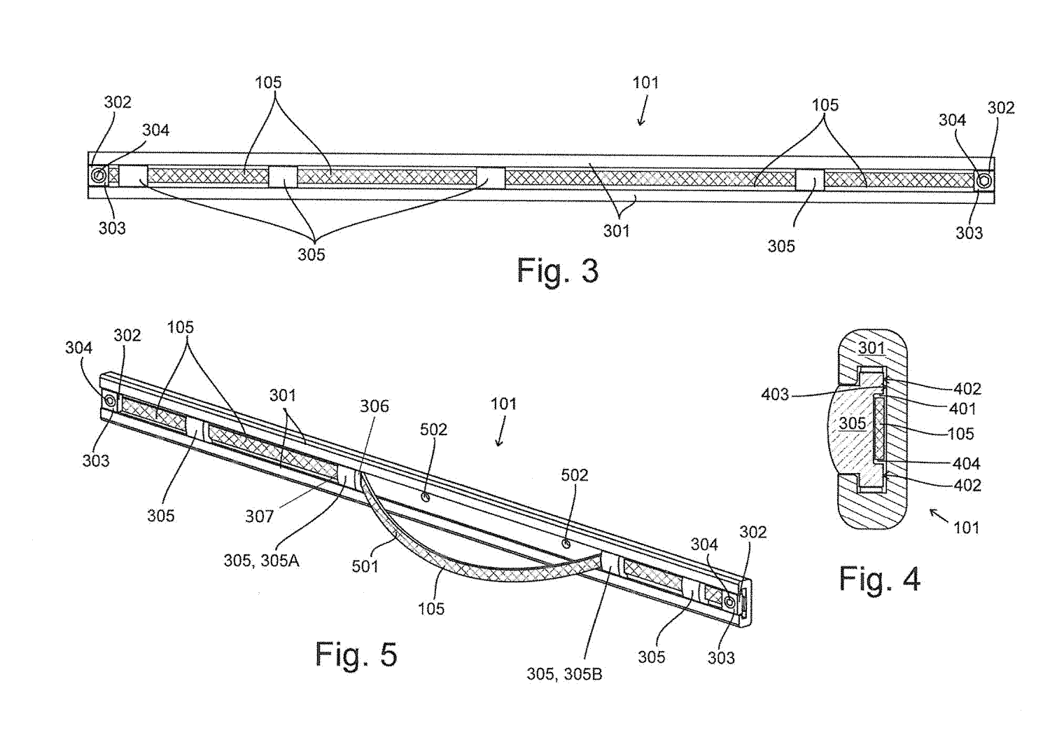

The apparatus 101 is shown in a front view in FIG. 3, a cross-sectional side view in FIG. 4 and a perspective view in FIG. 5. The apparatus 101 comprises a rail 301 and the strap 105 attached to the rail 301 at at least one anchor point 302. In the present embodiment, the apparatus 101 comprises two anchor points 302, one at each end of the rail 301, but in other embodiments more than two anchor points may be provided. In the present embodiment the anchor points 302 are immovable and at the anchor points 302 the strap 105 cannot move with respect to the rail 301.

However, in alternative embodiments the anchor points 302 may be releasably fixed in position along the rail 301 and/or the strap 105 may be adjustable at the anchor point 302. For example, a buckle may be fixed to the rail 301 at the anchor point 302 to enable the strap 105 to be momentarily released and pulled through the buckle.

In the present embodiment, the strap 105 is clamped to the rail 301 at the anchor points 302 by clamping members 303 that clamp the strap 105 against the rail 301 under pressure applied by fasteners 304 passing through the clamping members and the rail 301. Other means of fixing the strap 105 to the rail 301 at the anchor points 302 may be used in other embodiments. For example, anchor members may be bonded or fused to the strap 105, and the anchor members may then be fixed to the rail with fasteners or clipped into apertures formed in the rail 301. A further method of anchoring the strap 105 on the rail will be described below with reference to FIG. 16.

The apparatus 101 also comprises at least one slidable component 305. Each slidable component 305 defines a passageway 401 (shown in FIG. 4) through which the strap 105 extends. In the present embodiment there are four slidable components 305, but it will be understood that more or less than four slidable components 305 may be included in the apparatus 101. The slidable components 305 are mounted to slide along the rail 301, towards and away from the anchor points 302 and towards or away from each other. Also, the slidable components 305 are configured to slide along the strap 105 as they are slid along the rail 301. Consequently, the slidable components 305 divide up the strap 105 into several sections, each section extending between an anchor point 302 and a slidable component 305 or between two slidable components, and the length of the sections of strap 105 may be adjusted by sliding the slidable components 305 along the rail 301. As will be described in further detail below, this enables different items of various dimensions to be retained between the strap 105 and the rail 301.

As shown in FIG. 4, the passageway 401 is defined by a gap between the slidable member 305 and the rail 301. In the present embodiment this is achieved by the slidable member 305 having a recess 404 in its first bearing surface 402 that rests on an end bearing surface 403 of the rail 301.

In the present embodiment, the strap 105 comprises resilient fibres to enable it to stretch under manually applied tension. For example, the strap 105 may be formed of polyester elasticated webbing. In other embodiments the strap 105 may be formed of other types of material that stretch sufficiently under manually applied tension to enable the strap to be looped around items commonly carried in the loadspace 103, but only stretch under such tension that is sufficient to hold such items in place.

The strap 105 is shown in FIG. 5 after having been stretched by pulling a section 501 of the strap 105 between two of the slidable components 305, i.e. the slidable components 305A and 305B. In this stretched state, the strap 105 may bear against the slidable components 305A and 305B, which may force the slidable components 305A and 305B against the rail 301. In this manner, tensioning the section 501 of the strap 105 may generate friction between the slidable components 305A and 305B and the rail 301. The generated friction may substantially inhibit movement of the slidable components 305A and 305B along the rail 301

For example, the tensioned strap 105 may bear against an edge of the recess 404 at a first end 306 of the slidable component 305A, which may force the first end 306 of the slidable component 305A against retaining surfaces of the rail 301. The force may generate sufficient friction between the slidable component 305A and the rail 301 to inhibit movement of the slidable component 305A.

Alternatively, or additionally, the force on the edge of the recess 404 may raise the first end 306 of the slidable component 305A relative to an opposing second end 307 of the slidable component 305A, tilting the slidable component 305A and causing at least one end of the slidable component 305A to pinch or forcibly bear against the rail 301.

For example, the stretched strap 105 may tilt the slidable component 305A in a manner that forces the first end 306 of the slidable component 305 against the retaining surfaces of the rail 301 and forces the second end 307 of the slidable component 305A against the end bearing surface 403 of the rail 301. The friction generated between the rail 301 and each end of the slidable component 305A may substantially inhibit movement of the slidable component 305A along the length of the rail 301. In this case, an individual may move the slidable component 305A along the rail 301 by depressing the raised end of the slidable component 305A, to align the slidable component 305A with the length of the rail 301, before applying a force directed along the rail 301.

It should be appreciated that equivalent effects may occur at the other end of the strap section 501, with the second slidable component 305B also being forced against the rail 301 such that the second slidable component 305B is restrained. The rail 301 may be provided with one or more features 502 to enable attachment of the rail 301 to a surface of a vehicle. The features 502 may comprise holes formed in the rail 301 to receive a fastener, such as a screw, used to fix the rail 301 to a panel.

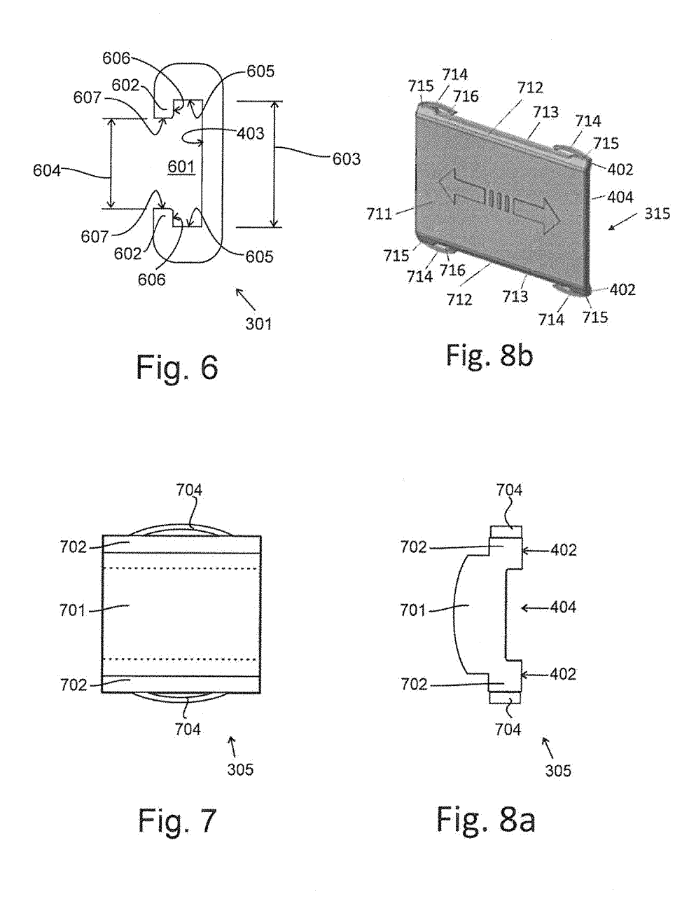

An end view of the rail 301 of the apparatus 101 of FIGS. 3 to 5 is shown in FIG. 6. The rail 301 defines a groove 601 along its length (into the page in FIG. 6). The groove 601 has inwardly extending lips 602 along its opening and consequently the groove has a T-shaped cross-section having a base of a first width (indicated by arrow 603) and an opening of a second width (indicated by arrow 604) that is narrower than the first width 603. The groove 601 is defined by: the end bearing surface 403, which extends across the base of the groove 601; side bearing surfaces 605 that extend away from the end bearing surface 403; retaining surfaces 606 on the inwardly extending lips 602; and guide surfaces 607 on the inwardly extending lips 602.

The rail 301 may be formed as an extrusion or cast, for example from aluminium alloy.

One of the slidable components 305 is shown in a front view in FIG. 7 and in a side view in FIG. 8a. It should be understood that each of the slidable components 305 may be identically configured to each of the other slidable components 305. As shown in FIG. 8a, the slidable component 305 has a generally T-shaped outer profile so that it provides a good sliding fit in the groove 601 of the rail 301. The slidable component 305 therefore comprises: a main body 701 configured to be a good sliding fit between the guide surfaces 607 on the inwardly extending lips 602; and flanges 702 extending from opposing sides of the main body 701. The flanges 702 are configured to extend behind the inwardly extending lips 602 (as may be seen in FIG. 4) and therefore enable the slidable component 305 to be retained within the groove 601.

Outer faces 703 of the flanges 702 may be provided with spring parts 704 that are dimensioned such that the spring parts 704 must be flexed towards the flanges 702 to fit between the side bearing surfaces 605 of the groove 601. The spring parts 704 therefore provide additional friction between the slidable member 305 and the rail 301 to prevent unwanted movement of the slidable component 305 during use. In the present embodiment, the slidable component 305 is moulded from a plastics material and the spring parts 704 are moulded as integral parts of the slidable component 305. However, in alternative embodiments one or more spring parts may be formed separately from the main body 701 and connected to the main body by a spring. In other alternative embodiments the slidable components 305 may not comprise any spring parts 704 at all.

Another example of the slidable component is shown in a perspective view in FIG. 8b with like features being assigned like reference numbers that are incremented by 10.

As in the previous example, shown in FIG. 8a, the slidable component 315 comprises: a main body 711 and flanges 712 extending from opposing sides of the main body 711. The slidable component 315 is mounted on a corresponding rail (not shown, but referenced in this example using like reference numerals to aid the reader's understanding) in the manner described in the previous example. In particular, the main body 711 is configured to provide a sliding fit between complementary guide surfaces 607 on the rail 301 and the flanges 712 are configured to retain the slidable component 315 within a complementary groove 601 on the rail 301.

As illustrated in FIG. 8b, the slidable component 315 also features a plurality of spring parts 714 that extend from outer faces 713 of the flanges 712. In this example, the spring parts 714 are flexible projections that extend away from the main body 711. The spring parts 714 may, for example, extend from one or more corners 715 of the slidable component 315 or from each corner 715 of the slidable component 315, as shown in FIG. 8b. The spring parts 714 may extend at an inclined angle relative to the sides of the main body 711.

In use, each spring part 714 may be configured to engage side bearing surfaces 615 of the groove 601. For example, the spring parts 714 may be configured to engage the side bearing surfaces 605 of the groove 601 so as to provide friction between the slidable member 315 and the rail 301. The friction may substantially inhibit movement of the slidable component 315 upon application of a force directed along the rail 301.

The spring parts 714 may, for example, be configured to allow a limited amount of rotation of the slidable component 315 within the groove 601. For example, upon application of a twisting force, the spring parts 714 on respective pairs of diagonally opposing corners 715 of the slidable component 315 may alternately be compressed, and deflected towards the main body 711; or decompressed, such that they distend away from the main body 711. In this manner, the rotation of the slidable component 315 may, at least transiently, reduce the friction between the spring parts 714 and the groove 601.

As shown in FIG. 8b, each flange 712 may, for example, include a recess 716 that extends between spring parts 714 to accommodate the deflection of the spring parts 714 towards the main body 711.

Accordingly, the slidable component 315 may, for example, be moveable along the length of the rail 301 by twisting the slidable component 315 in alternating directions, whilst simultaneously applying a force directed along the length of the rail 301. In other words, the slidable component 315 may be translated along the rail 301 using a rocking motion. This may be advantageous because the retained items are likely to exert at least some force that acts to push the slidable component 315 along the length of the rail 301, but the retained items are unlikely to apply such force whilst rocking the slidable component 315 in alternating directions. Hence, the spring parts 714 may prevent unwanted movement of the slidable component 315 during use, but allow an individual to adjust the position of the slidable component 315 as desired.

As in the example of FIG. 8a, the slidable component 315 may, for example, be moulded from a plastics material and the spring parts 714 may be moulded as integral parts of the slidable component 315. Alternatively, one or more spring parts 714 may, for example, be formed separately from the main body 711 and connected to the main body 711 by a spring.

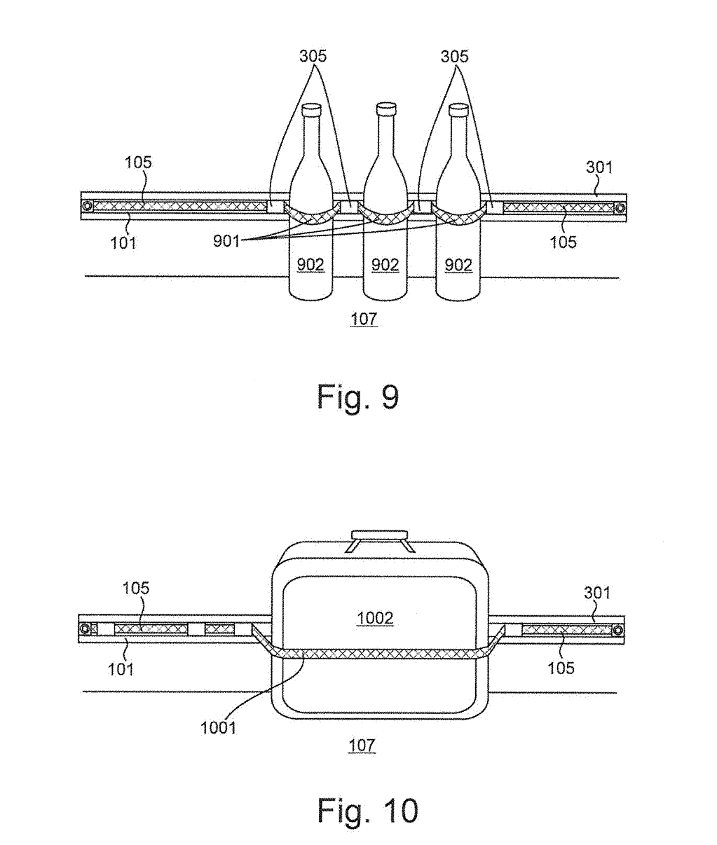

The apparatus 101 is shown in use in FIGS. 9 and 10. In FIG. 9, the four slidable components 305 have been pushed along the rail 301 to positions where the slidable components 305 are relatively close together, so that each slidable component 305 is separated from its nearest neighbour by a relatively short section of the strap 105. Each section 901 of the strap 105 that extends between a pair of slidable components 305 has been pulled away from the rail 301 and looped over a respective bottle 902 that stands on the floor 107 of a loadspace of a vehicle.

Tension in the strap 105 pulls the bottles 902 against the rail 301, enabling the bottles 902 to maintain their upright position during movement of the vehicle. In the present embodiment, the tension is produced in the strap 105 by stretching the strap 105 around the items 902.

In FIG. 10, two neighbouring slidable components 305B and 305C have been slid apart so that a section 1001 of the strap 105 between them is sufficiently long to stretch around an item of luggage 1002 that stands on the floor 107. Tension in the strap 105 pulls the item of luggage 1002 against the rail and prevents it from falling over and sliding around the floor 107 of the loadspace during movement of the vehicle.

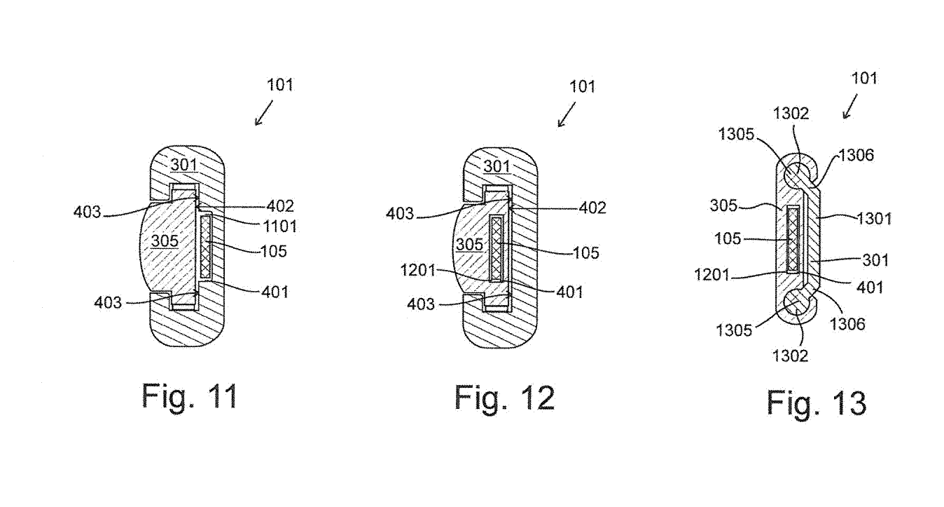

An alternative apparatus 101 embodying the present invention is shown in the cross-sectional side view of FIG. 11. The apparatus 101 of FIG. 11 may be like that of FIG. 5 except as follows. In this embodiment, the passageway 401 through which the strap 105 extends is provided by the end bearing surface 403 of the rail 301 having a recess 1101 extending along the length of the rail 301. The bearing surface 402 of the slidable components 305 may be flat as shown in FIG. 11, or may also be recessed.

In further alternative embodiments, such as the apparatuses 101 shown in the cross-sectional side views of FIGS. 12 and 13, the passageway 401 may be wholly defined by the slidable component 305. In these embodiments, the passageway 401 is provided as a slot 1201 that extends through the slidable component 305.

In FIGS. 5, 11 and 12, the slidable member 305 is retained within a groove 601 of the rail 301 by inwardly extending lips 602 at the opening of the groove 601. In contrast, in some alternative embodiments, the slidable components 305 may be provided with grooves that enclose one or more tracks that extend along a rail 301. FIG. 13 provides an example of such an embodiment. The apparatus 101 of FIG. 13 includes a rail 301 comprising a backplate 1301 and two tracks 1302 extending along the length of the rail 301. Each of the tracks has a relatively wide head portion 1305 supported from the backplate 1301 by a relatively narrow neck portion 1306. Grooves 1304 in the slidable components 305 have inner bearing surfaces that are configured to slide along the outer surface of the head portions 1305 of the tracks 1302.

An alternative apparatus 101A embodying the present invention is shown in the perspective view of FIG. 14. The apparatus 101A comprises a rail 301 that is integrally formed as part of a panel 1401.

The apparatus 101A comprises a strap 105 and slidable components 305 that may be configured in the same way as those described above for apparatus 101. The panel 1401 may also comprise a groove 601 that is configured internally like the groove 601 of the rail 301 of apparatus 101. The groove 601 extends along a front face 1402 of the panel 1401 from one end 1403 of the front face 1402 to the opposite end 1404 of the front face 1402. The strap 105 extends along the whole length of the panel 1401 between its two ends 1403 and 1404, and an end cap 1405 is attached to each end 1403 and 1404 of the panel.

The panel 1401 may be used as a partition in a loadspace 103 of a vehicle 100, such as the panel 201 shown in FIG. 2, or it may form at least a part of an outer wall of the loadspace 103, or it may provide a surface at the rear of the rear seats of the vehicle 100, such as the surface 104 of FIG. 1.

The apparatus 101A may be used in a similar way as the apparatus 101 of FIGS. 3 to 5 described above. i.e. the slidable components 305 may be slid along the groove 601 to divide up the strap 105 into sections that are a suitable length to stretch around, and retain in position, an item that is to be carried within the loadspace 103 of a vehicle 100. However, whereas the rail 301 of the apparatus 101 of FIGS. 3 to 5 was attached to a panel or wall in the loadspace 103, the apparatus 101A of FIG. 14 is a panel that includes the rail 301.

The panel 1401 is shown without the end caps 1405, the strap 105 and the slidable components 305 in FIG. 15. The panel 1401 is formed as an extrusion with several cavities 1501 extending along its length parallel to the groove 601. The extrusion comprises a wall 1502 that divides one of the cavities 1501A from the groove 601.

A cross-section of an end portion of the apparatus 101A is shown in FIG. 16. The cross-section is parallel to the groove 601 and through the strap 105, the cavity 1501A and the end cap 1405. An end portion 1601 of the strap 105 extends out of the end of the groove 601 at the end 1404 of the panel 1401 and wraps around the end of the wall 1502 into the cavity 1501A. A plug 1602 is disposed within the end of the cavity 1501A to trap the end portion 1601 of the strap 105 in the cavity 1501A and anchor it in place. In the present embodiment, the plug 1602 is formed of a plastics material, for example by injection moulding, and it forms a part of the end cap 1405.

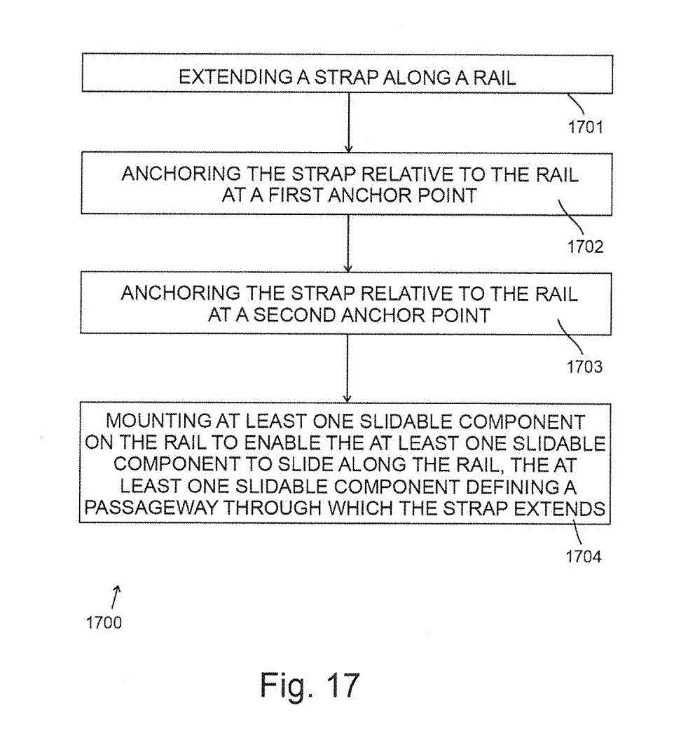

A method 1700 of manufacturing apparatus 101 for retaining an item carried by a vehicle 100 is illustrated by the flowchart shown in FIG. 17. The method 1700 comprises, at block 1701, extending a strap 105 along a rail 301.

The rail 301 may have been formed by an extrusion process or a casting process. The rail 301 may be provided with features such as drilled holes 502 to enable the rail to be attached to a panel, or the rail 301 may be formed as an integral part of the panel by an extrusion process or a casting process.

The rail 301 typically comprises a groove 601 and the strap 105 is extended alongside the rail 301 within the groove 601 at block 1701.

At block 1702, the method includes anchoring the strap 105 relative to the rail 301 at a first anchor point 302. This process may comprise attaching the strap 105 to the rail 301, for example as illustrated in the embodiment of FIG. 3, or attaching the strap 105 to another object such as a panel (such as panels 108 or 201) to which the rail 301 is fixed.

The first anchor point 302 may be a fixed anchor point 302. For example, the strap 105 may be clamped to the rail 301 at an anchor point; or a fastener such as a buckle may be fixed in position to the rail at the anchor point and the strap 105 attached to the rail using the buckle; or the strap 105 may extend into a cavity 1501A formed in the rail 301 and fixed in place as described with reference to FIG. 16. Alternatively, the anchor point 302 may be moveable. For example, a buckle may be attached to the rail 301 so that it is moveable, and the strap 105 may then be fixed to the buckle. This may also enable the position at which the strap 105 is attached to the buckle to be adjusted.

At block 1703, the method 1700 includes anchoring the strap 105 relative to the rail 301 at a second anchor point 302. Like the process at block 1702, the process at block 1703 may comprise attaching the strap 105 to the rail 301, for example as illustrated in the embodiment of FIG. 3, or attaching the strap 105 to another object such as a panel to which the rail is fixed. Like the first anchor point 302, the second anchor point 302 may be a fixed anchor point 302 or alternatively the anchor point 302 may be moveable. The means of attaching the strap 105 at the second anchor point 302 may also enable adjustment of the position along the strap 105 at which it is attached. For example, the means of attaching may comprise a buckle configured to enable the strap to slide through and to releasably engage the strap 105.

The method 1700 further comprises, at block 1704, mounting at least one slidable component 305 on the rail 301 to enable the at least one slidable component 305 to slide along the rail 301, the at least one component 305 defining a passageway 401 through which the strap 105 extends. In embodiments in which the rail 301 has a groove 601 with an open end, this may be achieved by sliding the slidable components 305 into the groove 601 formed in the rail 301. In other embodiments the slidable components 305 may be mounted on the rail 301 by sliding them onto tracks 1302, such as those shown in FIG. 13, that are formed along the rail 301. The process at block 1704 may comprise mounting the slidable components 305 onto the rail 301 with the strap 105 positioned between the slidable components 305 and the rail 301 so that the strap 105 extends through a passageway defined between each slidable component 305 and the rail 301.

The blocks illustrated in the FIG. 17 may represent steps in a method. The illustration of a particular order to the blocks does not necessarily imply that there is a required or preferred order for the blocks and the order and arrangement of the blocks may be varied. For example, means for attaching the strap 105 to the rail 301 at block 1702 and/or block 1703 may prevent the slidable components 305 from being slid off and on the rail 301. In such embodiments the process at block 1704 of mounting the slidable components 305 on the rail 301 may be performed before attaching the strap 105 to the rail 301 at block 1702 and/or block 1703. Furthermore, in embodiments in which the strap 105 passes through an enclosed slot 1201 formed in the slidable components 305, such as the slots 1201 shown in FIGS. 12 and 13, the strap 105 may be inserted through the slidable components 305 before the slidable components are mounted on the rail 301. Thus, the process of extending the strap 1701 along the rail 301 at block 1701 and the process of mounting the slidable components 305 at block 1704 are performed as a single process.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus for retaining an item carried by a vehicle, the apparatus comprising:
a rail;
a strap anchored relative to the rail at a first anchor point; and
at least one component defining a passageway, between the at least one component and the rail, through which the strap extends, the at least one component being mounted to slide along the rail, towards and away from the first anchor point, to enable different items of various dimensions to be retained between the strap and the rail.

2. The apparatus according to claim 1, wherein the strap is anchored relative to the rail at at least two anchor points and the at least one component is mounted to slide along the rail between the two anchor points.

3. The apparatus according to claim 2, wherein the strap is fixed to the first anchor point at, or adjacent to, one end of the rail and fixed to a second anchor point at, or adjacent to, an opposite end of the rail.

4. The apparatus according to claim 1, wherein the strap comprises elastic fibres to enable the strap to stretch.

5. The apparatus according to claim 1, wherein the at least one component divides the strap into a plurality of portions, each said portion being useable to retain an item.

6. The apparatus according to claim 1, wherein the apparatus comprises a plurality of the components.

7. The apparatus according to claim 1, wherein the rail is positioned on a panel configured to be mounted within a loadspace of a vehicle to define the loadspace.

8. The apparatus according to claim 1, wherein the rail comprises features to enable attachment of the rail to a surface of a vehicle.

9. The apparatus according to claim 1, wherein the apparatus further comprises a panel, and wherein the rail forms an integral part of the panel.

10. The apparatus according to claim 1, wherein the strap is attached to the rail at at least the first anchor point.

11. A vehicle comprising the apparatus of claim 1.

12. The vehicle according to claim 11, wherein the rail is provided on an interior surface of the vehicle.

13. The vehicle according to claim 12, wherein the interior surface is provided in a loadspace.

14. The vehicle according to claim 13, wherein the interior surface is on a panel configured to partition the loadspace.

15. A method of manufacturing an apparatus for retaining an item carried by a vehicle, the method comprising:
extending a strap along a rail;
anchoring the strap relative to the rail at a first anchor point; and
mounting at least one component on the rail to enable the at least one component to slide along the rail, the at least one component defining a passageway, between the at least one component and the rail, through which the strap extends.

16. The method according to claim 15, wherein said mounting the at least one component on the rail comprises sliding the at least one component onto the rail with the strap positioned between the at least one component and the rail.

17. The method according to claim 15, wherein the rail is formed by an extrusion process or a casting process.

18. The method according to claim 15, wherein the rail is formed as an integral part of a panel by an extrusion process or a casting process.

19. The apparatus according to claim 1, wherein the at least one component comprises: a body portion, flanges extending from opposing sides of the body portion, and a spring part; wherein the spring part extends from one of the flanges; and wherein the spring part is configured to engage a groove of the rail.

20. The apparatus according to claim 1, wherein the strap is configured to bear against at least one of the components and to raise a first end of said component relative to an opposing second end of said component when an item is retained between the strap and the rail, and wherein the component is moveable along the rail by depressing the raised first end of the component and sliding the component along the rail.
